(19) United States
(12) Patent Application Publication
(10) Pub. No.: US 2010/0333160 A1
(43) Pub. Date: Dec. 30, 2010

(54) SEGMENTATION OF MULTICAST DISTRIBUTED SERVICES

(75) Inventors: Christofer Flinta, Stockholm (SE); Svante Ekelin, Vallentuna (SE); Jan-Erik Mangs, Solna (SE); Bob Melander, Sigtuna (SE)

Correspondence Address: ROTHWELL, FIGG, ERNST & MANBECK, P.C., 1425 K STREET, N.W., SUITE 800, WASHINGTON, DC, 20005, US

(73) Assignee: Telefonaktiebolaget LM Ericsson (publ), Stockholm (SE)

(21) Appl. No.: 12/867,675

(22) PCT Filed: Feb. 14, 2008
(86) PCT No.: PCT/SE2008/050176

§ 371 Date: Aug. 31, 2010

(51) Int. Cl. H04N 7/173

(52) U.S. Cl. 725/116

(57) ABSTRACT

The present invention relates to methods and arrangements to optimize bandwidth usage in a Multicast Services Control System (MSCS) for digital information transport. The system comprises a service provider (Server) and service receivers (STB1-STB5) able to receive multicast streams from the service provider along multicast trees in an IP network (A/MNW). The method comprises the following steps: —A multicast join is performed by the service receivers to a multicast group associated with the service of interest provided by the service provider. —Bandwidth is measured on paths in a joined multicast tree. —Each of the service receivers (STB1-STB5) join an optimal multicast group (D1, D2, D3), which joining is based on the measurements.

### TECHNICAL FIELD

The present invention relates to methods and arrangements to optimize bandwidth usage in a multicast services control system for digital information transport.

### BACKGROUND

Multicast is well suited for distribution of services as IP-TV or video streaming. Multicast is the way IP TV is typically distributed in broadband networks. Set Top Boxes have an important role of receiving and rendering the TV image for the TV sets. A Set Top Box in broadband networks does this by standardized speaking Internet Group Management Protocol IGMP to the broadband network. The IGMP has been developed by the internet Engineering Task Force IETF as a standard that relates to the communication between router and subscribers. RFC2236 “Internet Group Management Protocol, version 2” describes the use of the IGMP standard. The Protocol starts and stops TV streams as well as channel changes. Traffic management is important in digital networks. Traffic management involves the controlling and scheduling of traffic through paths established through a network. The traffic can include audio, video, or any form of digital information. Channel streaming is used to take a group of digital information services and configure them to flow down into a digital network into several channels so as to get the digital information close to an end user so the end user can access the digital information very quickly. Such an implementation is made readily available for digital networks that have capacity, such as extra bandwidth, that enables the flow of digital services closer in proximity to an end user so that the end user can retrieve them more quickly. Channel streaming is intended to improve behaviour of almost any Ethernet topology. However, benefits of channel streaming become more important as the size of the network is increased, and the number of “hops” (i.e., transportation leaps between devices along a path in the broadband network) between a client and a server increases. A multicast services control system for internet protocol television transport can be seen in the US Patent Application 2006/0015928. A service distribution platform is hereby configured to receive channels from an internet protocol video, which channels are to be forwarded to at least one Set Top Box.

Measurement of network characteristics can be performed using methods which include active probing of the network, i.e. injecting dedicated probe packets for the sole purpose of the measurement method. One example is disclosed in the U.S. Pat. No. 6,868,094 wherein an IP performance monitoring method is shown. In the US patent a timing probe data packet containing a send time stamp is sent over the network from a sender to a receiver. A receive time stamp is written into the probe packet at the receiver. The probe packet is echoed by the receiver and the probe packets sender performs an analysis based upon the send stamp and receive stamp. Another example is the BART method for available bandwidth estimation, developed at Ericsson AB. Aspects of BART has been published at several conferences such as:
[1] S. Ekelin and M. Nilsson, “Continuous monitoring of available bandwidth over a network path”, 2^{nd} Swedish National Computer Networking Workshop, Karlstad, Sweden, Nov. 23-24, 2004.
[2] S. Ekelin, M. Nilsson, E. Hartikainen, A. Johnsson, J.-E. Mangs, B. Melander and M. Björkman, “Real-time measurement of end-to-end available bandwidth using Kalman filtering,” in Proc. 10th IEEE/IFIP Network Operations and Management Symposium, 2006.
[3] E. Hartikainen and S. Ekelin, “Tuning the Temporal Characteristics of a Kalman-Filter Method for End-to-End Bandwidth Estimation,” in Proc. 4th IEEE/IFIP Workshop on End-to-End Monitoring Techniques and Services, 2006.
[4] E. Hartikainen and S. Ekelin, “Enhanced Network-State Estimation using Change Detection,” in Proc. 1st IEEE LCN Workshop on Network Measurements, 2006.

The European Patent Application EP 1 624 632 discloses a method for transmission optimization for application level multicast. The European patent application describes that for each member of a video conference, a multicast tree is generated. An end-to-end transmission delay from each data source to each of the respective data recipients is determined, and the available bandwidth between each data source to each of the respective data recipients is determined. One or more of the multicast trees, each corresponding to a data source, are refined according to the end-to-end transmission delay and available bandwidth.

### SUMMARY

The present invention relates to problems how to optimize (or tailor) the streaming service for each subscriber within a multicast distribution flow along a multicast tree with several paths to different receiving subscribers. It is desirable to adapt the streaming to the actual existing situation for participating subscribers and thereby bring about best possible Quality of Service for each receiving subscriber. For instance, a high quality (and thereby high bandwidth) flow will be convenient for a high bandwidth subscriber but be catastrophic for the low bandwidth subscriber.

The problem is solved by the invention by adding a measurement-driven mechanism to setup and segment a multicast distributed service into multiple multicast distribution flows. The invention hereby tailors the different flows with respect to some specific connectivity property, e.g. available bandwidth. The measurement driven mechanism provides estimates of connectivity properties and optimize the distribution flows. A server hereby initiates measurement of for example available bandwidth along multicast paths and based on the measurements, a multicast receiving client may join an optimal multicast group to use its service.

The solution to the problem in some more details is a method to optimize bandwidth usage in a Multicast Services Control System for digital information transport. The Multicast Services Control System comprises a service provider, and service receivers that are able to receive multicast streams from the service provider along multicast trees in an IP network. The method comprises the following steps:
The service receivers perform a multicast join to a group associated with the service of interest that is provided by the service provider.
Bandwidth is measured on paths in the joined multicast tree. Bandwidth here refers to the link capacity or the unused part thereof (the available bandwidth). The bottleneck link capacity of a path corresponds to the link capacity of the link with the smallest available bandwidth of the links on the path. The available bandwidth of a path corresponds to the smallest available bandwidth of the links on the path.
Each of the service receivers joins an optimal multicast group. The joining is based on the attained available bandwidth measurements.

In one embodiment of the invention, the service provider initiates measurement of available bandwidth by sending probe packets along paths in the multicast tree towards the service receivers. Obtained measures of available bandwidths on each path are returned from each service receiver to the service provider. The service provider elaborates by means of the received measurements, a set of optimal multicast groups. The set of optimal multicast groups is announced by the server to the receivers and placed at the receiver's disposal.

In another embodiment of the invention, the service provider initiates measurement of available bandwidth and when measures are obtained by the service receivers, the service receivers select, in dependence of the obtained measurements, an optimal multicast group among a set of pre-configured multicast groups.

As an alternative, the service provider instead initiates measurement of bottleneck link capacity on the paths and when measurements are obtained by the service receivers, the service receivers select, in dependence of the obtained measurements, an optimal multicast group among a set of multicast groups.

An object with the invention is to optimize the multicast service quality to subscribers by adapting quality to each subscriber's connectivity property. This object and others are achieved by methods, arrangements, nodes, systems and articles of manufacture.

An advantage with the invention is that multicast-based services are allowed to be optimized to connectivity properties of actual subscribers.

Another advantage is that the invention is applicable to any multicast based service for which a measurable connectivity property can be identified as crucial.

A further advantage is that the end-to-end method relies only on server and subscriber hosts and requires no assistance from intermediate nodes.

The invention will now be described more in detail with the aid of preferred embodiments in connection with the enclosed drawings.

### BRIEF DESCRIPTION OF THE DRAWINGS

FIG. 1 discloses a block schematic illustration of a multicast services control system wherein a service provider multimedia streams to receivers, through a Broadband Network.

FIG. 2 discloses a signal sequence diagram illustrating a method according to the first embodiment of the invention.

FIG. 3 discloses a signal sequence diagram illustrating a method according to the second embodiment of the invention.

FIG. 4 discloses a flowchart illustrating some essential method steps of the invention.

FIG. 5 discloses a block schematic illustration of a system that can be used to put the invention into practice.

### DETAILED DESCRIPTION

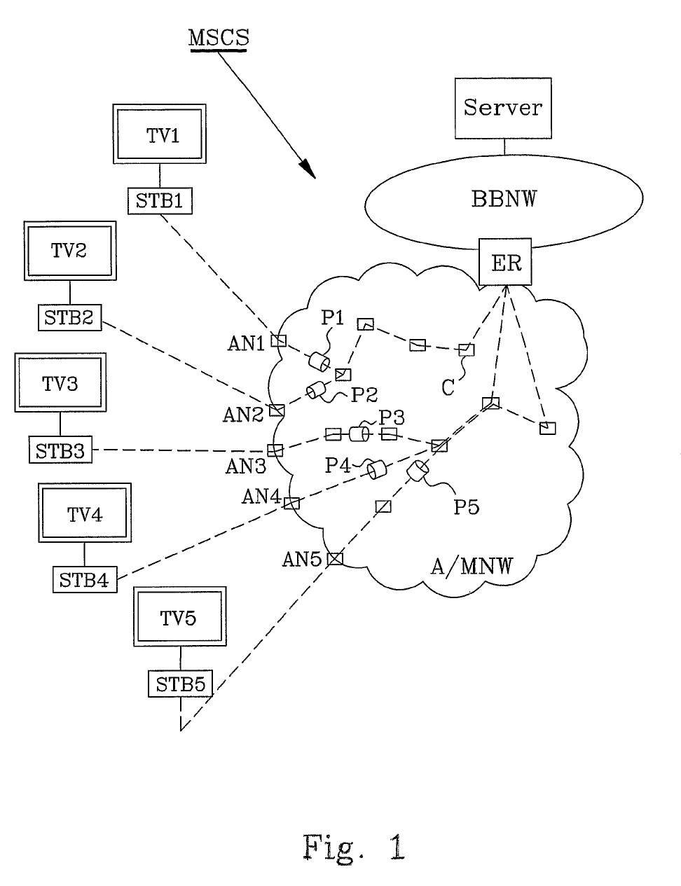

FIG. 1 discloses a block schematic illustration of a multicast services control system MSCS for digital information transport, in this example the information transport is equal to internet protocol transport. The system in the example comprises a Broadband Network i.e. an Access/Metro Network A/MNW that comprises Access Nodes AN1-AN5 (e.g. DSLAMs) and a number of concentrators C. In the figure, for figure clarity reasons only one of the concentrators is shown with a reference sign C. Five paths P1-P5 can be seen in the figure. Each path represents a multicast passage through connectors C between an Access Node and an Edge Router ER. Each one of the Access Nodes AN1-AN5 is attached to a Set Top Box STB1-STB5. The AN1 for example is attached to a Set Top Box STB1 and the concentrators C direct an incoming multimedia stream through the network from ER to AN1 and vice versa. The concentrators C handle the multimedia stream distribution using multicast routing and forwarding. The Access/Metro Network is attached to a backbone Network BBNW via the Edge Router ER. A service provider, also referred to as a Server, is attached to the BBNW for providing a range of TV channels to be delivered to the A/MNW. Based upon IGMP join signals and multicast routing and forwarding, selected channels can be directed from the Server through the Broadband Network A/MNW, via the concentrators, to a channel ordering client. The server is only responsible for feeding the network with the channel stream(s). Each client is represented in this example by a High Definition TV set TV1-TV5. To be observed is that any kind of terminal such as for example an ordinary TV set or computer terminal can be used.

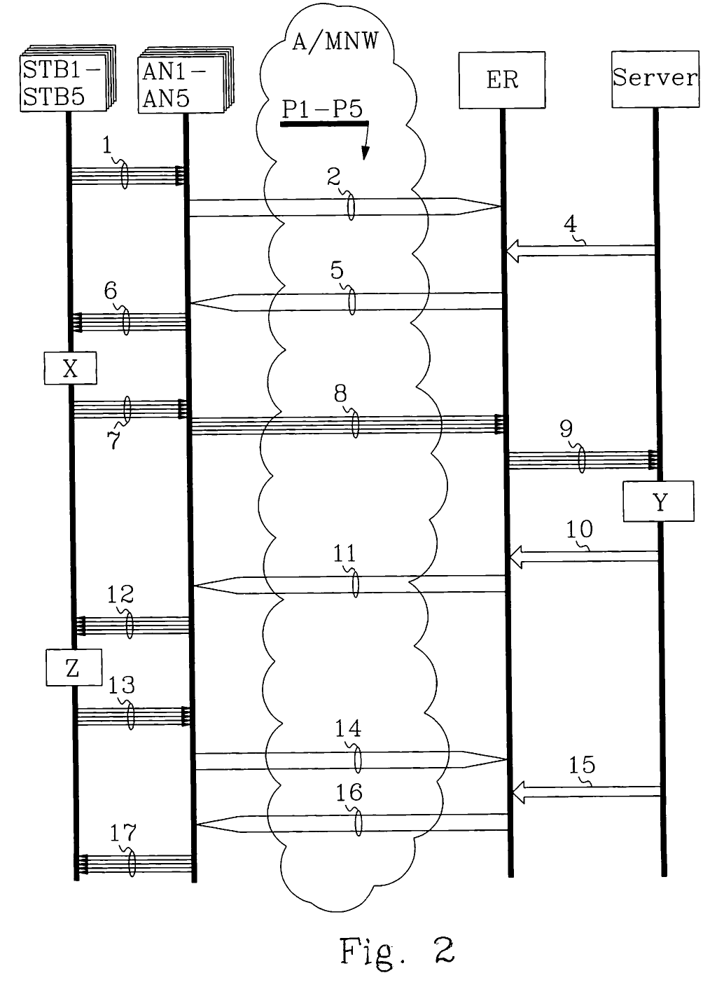

FIG. 2 discloses a signal sequence diagram representing a method to optimize multicast service quality to subscribers according to a first embodiment of the invention. The Set Top Boxes STB1-STB5 (also called service receivers), the Access Nodes AN1-AN5, the Edge Router ER and the Server have already been explained in FIG. 1, and they all represent signalling nodes in the signal sequence diagram in FIG. 2. The Access/Metro Network A/MNW shown more in detail in FIG. 1, is represented by a cloud symbol in FIG. 2. The constellations of paths P1-P5 are schematically represented by broad arrow symbols or blocks in FIG. 2. A method according to the first embodiment of the invention will now be explained together with FIG. 2. A prerequisite for the method according to the invention is that a service e.g. the streaming of a sports event has been announced to potentially subscribing receivers. The service is represented by a multicast IP address D (not shown in the figure). D is in this example presented to the Set Top Boxes STB1-STB5. The method comprises the following steps:
Each one of the Set Top Boxes STB1-STB5 announces an interest to the sports event by sending an IGMP multicast join request 1 to their respective Access Node AN1-AN5. In FIG. 2 this is shown with five arrow symbols; one from STB1 to AN1, one from STB2 to AN2 etc. The five multicast join requests 1 are each one specifying the multicast group IP address D.
The routing and forwarding of packets destined to multicast address D through the network A/MNW and ER is performed according to standardized well-known multicast routing schemes. This is shown in FIG. 2 with a block symbol 2 in A/MNW between Access Nodes and the Edge Router.
According to the invention, the server once, periodically or continuously performs measurement of available bandwidth (or bottleneck link capacity) along paths in the multicast tree. The server sends probe packets 4 with destination address D according to any, by those of skill in the art, well known method.
The Edge Router and A/MNW forward 5 by multicast the probe packet stream towards AN1-AN5 on the paths P1-P5, using the multicast IP address D as destination address. The Edge Router and C:s hereby use the multicast routing tables they hold. In this example, the probe packets firstly will be sent to three concentrators (see FIG. 1) and then, the packets will find their way, using multicast routing tables, on the paths P1-P5 until the Access Nodes AN1-AN5 are reached.
Probe packets are forwarded 6 from each of the receiving Access Nodes AN1-AN5 to their attached Set Top Boxes STB1-STB5.
When packets are received to the Set Top Boxes a measuring algorithm, e.g. the Bart algorithm mentioned in the background part of this application, calculates X available bandwidth along each path P1-P5 respectively.
The Set Top Boxes forward 7, 8, 9 the calculated available bandwidth to the Server by unicast using the Server IP address as destination address.
Upon reception of the available bandwidths, the Server starts to analyze Y the received bandwidths and subdivide the received bandwidths into groups according to a predefined scheme. In this example received available bandwidths for the paths P1-P5 are P1=0.5 Mbit/s, P2=0.6 Mbit/s, P3=1.1 Mbit/s, P4=1.7 Mbit/s and P5=1.8 MBit/s. Subdivision is performed and the bandwidths are in this example divided into three subgroups D1, D2, D3, namely D1=0.5 MBit/s (including P1 and P2), D2=1.0 Mbit/s (including p3) and D3=1.5 Mbit/s (including P4 and P5), each group is represented by a multicast IP address D1, D2 and D3 (not shown in the figure).
Information about the subgroups (multicast IP addresses) D1-D3 is sent 10, 11, 12 from the server to the receivers STB1-STB5 in a multicast stream in the same way as described before.
In dependence of each receiver's STB1-STB5 earlier estimated available bandwidth on the path P1-P5 belonging to it, each receiver selects Z which one of the three subgroups that is best suited. In this exemplified embodiment STB1 will select D1, STB2 will select D1, STB3 will select D2, STB4 will select D3 and STB5 will select D3.
STB1 subscribes to the sports event by sending an IGMP multicast join request 13 to Access Node AN1. The multicast join request specifies the multicast IP address D1 as multicast group address.
STB2 subscribes to the sports event by sending an IGMP multicast join request 13 to Access Node AN2. The multicast join request specifies the multicast IP address D1 as multicast group address.
STB3 subscribes to the sports event by sending an IGMP multicast join request 13 to Access Node AN3. The multicast join request specifies the multicast IP address D2 as multicast group address.
STB4 subscribes to the sports event by sending an IGMP multicast join request 13 to Access Node AN4. The multicast join request specifies the multicast IP address D3 as multicast group address.
STB5 subscribes to the sports event by sending an IGMP multicast join request 13 to Access Node AN5. The multicast join request specifies the multicast IP address D3 as multicast group address.
The routing and forwarding of packets destined to multicast address D1-D3 through the network A/MNW and ER is performed according to standardized well-known multicast routing schemes. This is shown in FIG. 2 with a broad arrow symbol 14 in A/MNW between Access Nodes and the Edge Router.
The service provider starts transmitting 15 the sports event using the bandwidths 0,5/1,0/1,5 MBit/s.
The Edge Router and A/MNW forward 16, 17 the sports event multicast stream towards STB1-STB2 on the paths P1-P2, using the multicast IP address D1 as destination address.
The Edge Router and A/MNW forward 16, 17 the sports event multicast stream towards STB3 on the path P3, using the multicast IP address D2 as destination address.
The Edge Router and A/MNW forward 16, 17 the sports event multicast stream towards STB4-STB5 on the paths P4-P5, using the multicast IP address D3 as destination address.

As an alternative to this example where receivers select Z which one of the three subgroups that is best suited, the service provider may designate a multicast group among the announced set of optimal multicast groups, to joined receivers. In this case the server sends out the designation together with the sending of the set of available multicast groups.

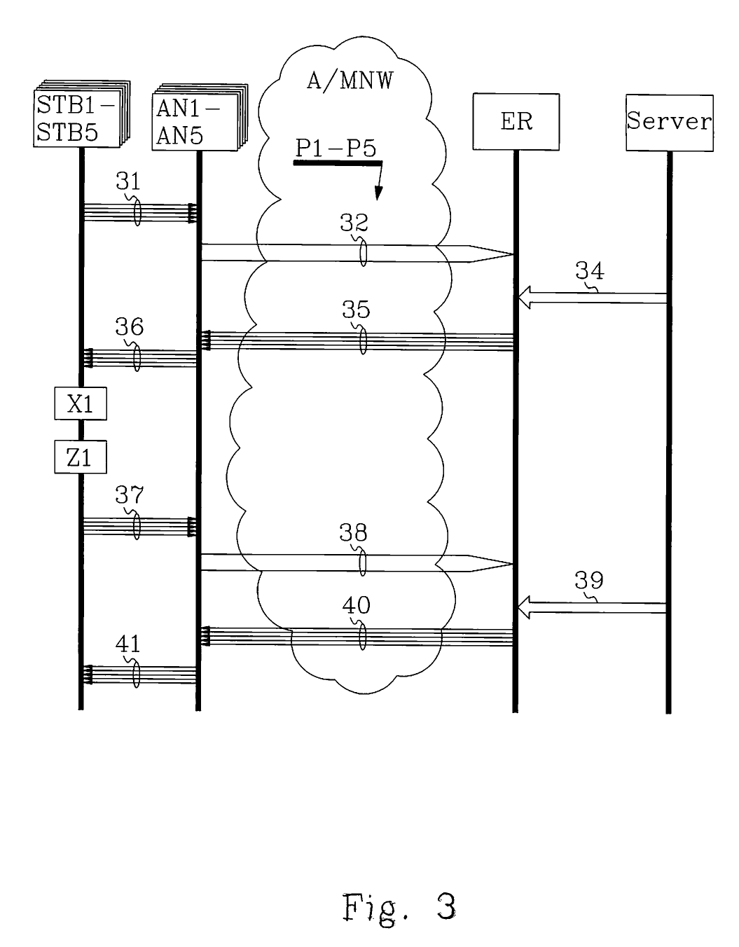

FIG. 3 discloses a signal sequence diagram representing a method to optimize multicast service quality to subscribers according to a second embodiment of the invention. The same nodes as in FIG. 2 represent signalling nodes in the signal sequence diagram in FIG. 3. A method according to the second embodiment of the invention will now be explained together with FIG. 3. Like before, a prerequisite for the method according to the invention is that a service has been announced to the Set Top Boxes STB1-STB5. In the embodiment that now will be described the service provider initiates measurement of available bandwidth and when measures are obtained by the service receivers, the service receivers select, in dependence of obtained measurements, an optimal multicast group among a set of pre-configured multicast groups. The method comprises the following steps:
Each one of the Set Top Boxes STB1-STB5 announces an interest to the announced service by sending an IGMP multicast join request 31 to their respective Access Node AN1-AN5. The five multicast join requests 1 are each one specifying the multicast group IP address E (not shown in the figure) in this example.
The routing and forwarding of packets destined to multicast address E through the network A/MNW and ER is performed according to standardized well-known multicast routing schemes. This is shown in FIG. 3 with a block symbol 32 in A/MNW between Access Nodes and the Edge Router.
According to the invention, the server once, periodically or continuously measures the available bandwidth (or bottleneck link capacity) along paths in the multicast tree. The server sends probe packets 34 with destination address E according to any known bandwidth estimation method.
The Edge Router and A/MNW forward by multicast the probe packet stream 35 towards AN1-AN5 on the paths P1-P5, using the multicast IP address E as destination address.
Probe packets are forwarded 36 from each of the receiving Access Nodes AN1-AN5 to their attached Set Top Boxes STB1-STB5.
When packets are received to the Set Top Boxes, a measuring algorithm calculates X1 available bandwidth along each path P1-P5 respectively. In this example received available bandwidths for the paths P1-P5 are P1=0.7 Mbit/s, P2=0.7 Mbit/s, P3=0.8 Mbit/s, P4=1.9 Mbit/s and P5=1.8 MBit/s.
Unlike in the previous embodiment, in this second embodiment the STBs have access to a set of multicast groups with different send bandwidth (i.e., rates). In this embodiment, in dependence of each receiver's STB1-STB5 available bandwidth on the path P1-P5 belonging to it, each receiver selects Z1 which one of the available subgroups that is best suited. The set of multicast groups can for example be pre-configured in the STBs or they can be accessible from for example a Web page. The bandwidths set consists in this example of three subgroups E1, E2, E3, namely E1=0.5 MBit/s, E2=1.0 Mbit/s and E3=1.5 Mbit/s, each group is represented by a multicast IP address E1, E2 and E3. In this exemplified embodiment the bandwidth set has been fetched in advance from a Web page and STB1 will select E1, STB2 will select E1, STB3 will select E1, STB4 will select E3 and STB5 will select E3.
STB1 subscribes to the service by sending an IGMP multicast join request 37 to Access Node AN1. The multicast join request specifies the multicast IP address E1 as multicast group address.
STB2 subscribes to the service by sending an IGMP multicast join request 37 to Access Node AN2. The multicast join request specifies the multicast IP address E1 as multicast group address.
STB3 subscribes to the service by sending an IGMP multicast join request 37 to Access Node AN3. The multicast join request specifies the multicast IP address E1 as multicast group address.
STB4 subscribes to the service by sending an IGMP multicast join request 37 to Access Node AN4. The multicast join request specifies the multicast IP address E3 as multicast group address.
STB5 subscribes to the service by sending an IGMP multicast join request 37 to Access Node ANS. The multicast join request specifies the multicast IP address E3 as multicast group address.
The routing and forwarding of packets destined to multicast address E1 and E3 through the network A/MNW and ER is performed according to standardized well-known multicast routing schemes. This is shown in FIG. 3 with a broad arrow symbol 38 in A/MNW between Access Nodes and the Edge Router.
The service provider starts transmitting 39 the sports event using the bandwidths 0.5, 1.0 and 1.5 MBit/s.
The Edge Router and A/MNW forward 40, 41 the sports event multicast stream towards STB1-STB3 on the paths P1-P3, using the multicast IP address E1 as destination address.
The Edge Router and A/MNW forward 40, 41 the sports event multicast stream towards STB4-STB5 on the paths P4-P5, using the multicast IP address E3 as destination address.

As an alternative to the above example where receivers select among groups that are pre-configured in the STBs or accessible from a Web page, the server can send out a set of optimal multicast groups at the same time as the probing is performed. Also in this case, like before a designation to each joined receiver can be sent out.

As already indicated, instead of measuring available bandwidth, the service provider may initiate measurement of bottleneck link capacity on the paths and when measures are obtained by the service receivers, the service receivers select, in dependence of the obtained measurements, an optimal multicast group.

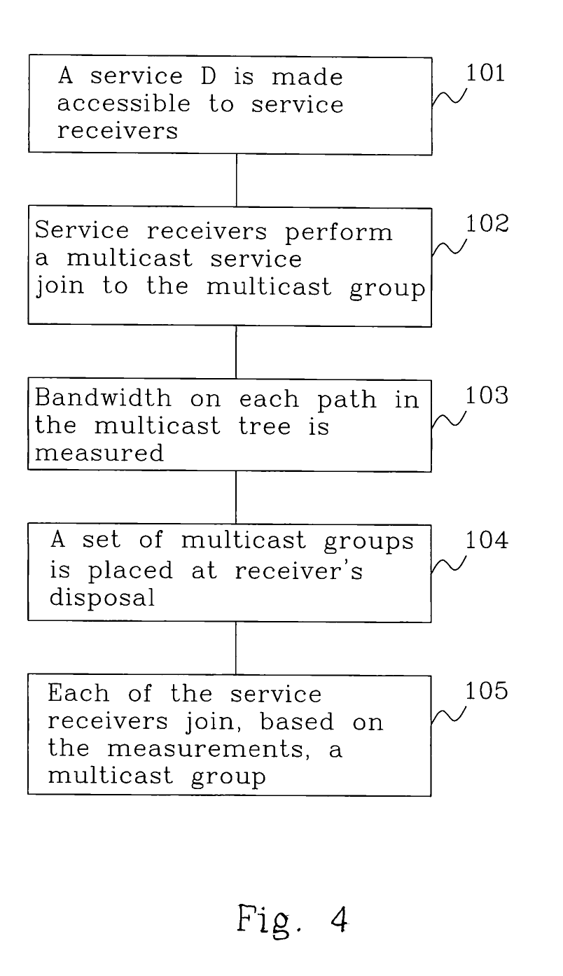

FIG. 4 discloses a flow chart in which some of the more important steps of the invention are shown. The flowchart is to be read together with the earlier shown figures. The flowchart comprises the following steps:
A service is made accessible by a service provider to potentially subscribing service receivers. The service is represented by a multicast IP address D. This step is disclosed in FIG. 4 with a block 101.
Service receivers announce an interest to the accessible service represented by D, by performing a multicast join to a multicast group. This step is disclosed in FIG. 3 with a block 102.
Available bandwidth on each path in the joined multicast tree is measured. Network performance is estimated for each path at the path end. This step is disclosed in FIG. 3 with a block 103.
A set of multicast groups is placed at the receiver's disposal. This step is disclosed in FIG. 3 with a block 104.
Each of the service receivers joins an optimal multicast group. The joining to a group is based on the measurements. This step is disclosed in FIG. 3 with a block 105.

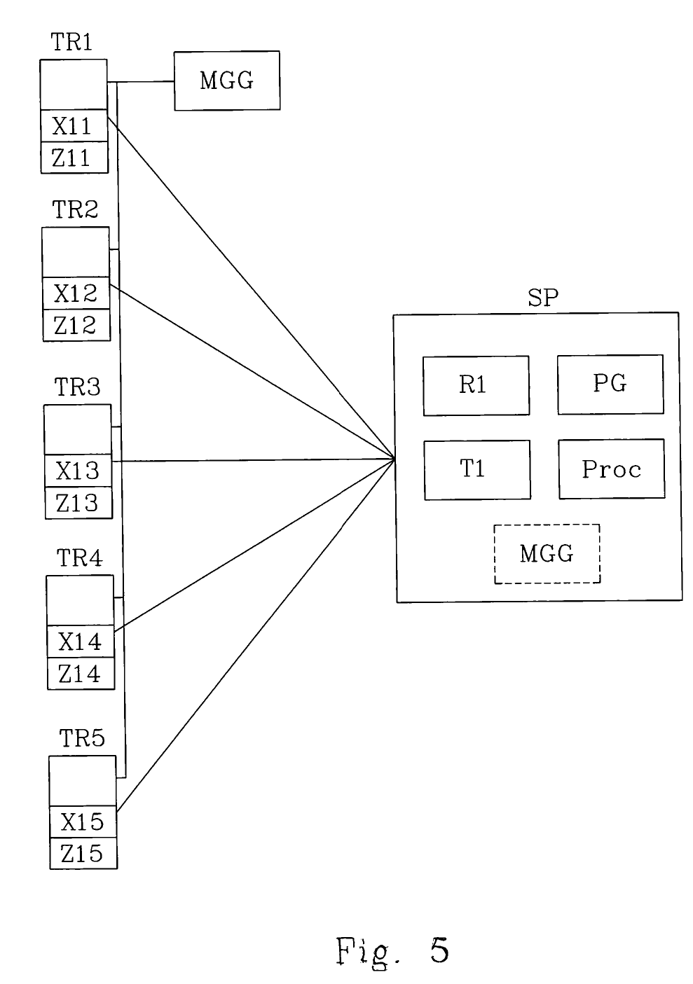

An example of a system used to put the invention into practice is schematically shown in FIG. 5. The block schematic constellation corresponds to the ones disclosed in FIGS. 1-3 but is by no means limited to these examples. FIG. 5 discloses a Service Provider SP (also called a service providing node) and five transceivers TR1-TR5 (also called service receiving nodes). The SP comprises a receiver R1 and a transmitter T1. R1 and T1 are used to receive/transmit signals from/to the transceivers TR1-TR5. The SP also comprises a Probe Generator PG used to send probe packets from the SP to the TR1-TR5. A Multicast Group Generator MGG is attached to each one of the transceivers TR1-TR5. The MGG is used to provide the transceivers with a set of multicast groups. As an alternative, the Multicast Group Generator MGG (here shown with dashed lines) can be located within the service provider SP and be responsible for generating the multicast groups after analyze of available bandwidth received from the transceivers TR1-TR5. In this case the generated multicast groups are sent from the SP to the TR1-TR5 on paths between the SP and transceivers. The service provider also comprises a processor unit proc that is responsible among other things for the co-ordinating of different entities within the SP. The processor may also be responsible for the designation of a multicast group to a receiver. Each one of the transceivers TR1-TR5 comprises a bandwidth estimator X11-X15 that is used to calculate bandwidth on the path between the SP and transceiver. Each one of the transceivers TR1-TR5 also comprises a multicast group selector Z11-Z15 that is used to select one multicast group out of the ones received for example from the multicast Group Generator MGG.

Items are shown in the figures as individual elements. In actual implementations of the invention however, they may be inseparable components of other electronic devices such as a digital computer. Thus, actions described above may be implemented in software that may be embodied in an article of manufacture that includes a program storage medium. The program storage medium includes data signal embodied in one or more of a carrier wave, a computer disk (magnetic, or optical (e.g., CD or DVD, or both), non-volatile memory, tape, a system memory, and a computer hard drive.

The invention is not limited to the above described and in the drawings shown embodiments but can be modified within the scope of the enclosed claims. The systems and methods of the present invention may be implemented for example on any of the third generation partnership project (3GPP), European telecommunications standards institute (ETSI), American national standards institute (ANSI) or other standard telecommunication network architecture. Other examples are the institute of electrical and electronics engineers (IEEE) or the Internet Engineering task force (IETF).

The description, for purposes of explanation and not limitation, sets forth specific details, such as particular components, electronic circuitry, techniques, etc., in order to provide an understanding of the present invention. But it will be apparent to one skilled in the art that the present invention may be practiced in other embodiments that depart from these specific details. In other instances, detailed descriptions of well-known methods, devices, and techniques, etc., are omitted so as not to obscure the description with unnecessary detail. Individual function blocks are shown in one or more figures. Those skilled in the art will appreciate that functions may be implemented using discrete components or multi-function hardware. Processing functions may be implemented using a programmed microprocessor or general-purpose computer.

The invention is in other words not limited to the above described and in the drawings shown embodiments but can be modified within the scope of the enclosed claims.

1. Method to optimize bandwidth usage in a multicast services control system (MSCS) for digital information transport, which system comprises a service provider (Server) and service receivers (STB1-STB5) able to receive multicast streams from the service provider along multicast trees in an IP network (A/MNW), which method comprises the following steps:
performing a multicast join by the service receivers to a multicast group associated with the service of interest provided by the service provider; characterized by
measuring bandwidth on paths in the joined multicast tree;
joining by each of the service receivers (STB1-STB5) an optimal multicast group (D1,D2,D3), which joining is based on the measurements.

2. Method to optimize bandwidth usage in a multicast services control system (MSCS) for digital information transport according to claim 1 wherein a set of optimal multicast groups (D1, D2, D3) is made available to the receivers.

3. Method to optimize bandwidth usage in a multicast services control system (MSCS) for digital information transport according to claim 2, wherein the set of optimal multicast groups (D1, D2, D3) is announced from the service provider (Server).

4. Method to optimize bandwidth usage in a multicast services control system (MSCS) for digital information transport according to claim 3, wherein measured bandwidth is sent from the subscribing receivers (STB1-STB5) to the service provider (Server), and whereby the announced set of optimal multicast groups (D1, D2, D3) is based on the received measurements.

5. Method to optimize bandwidth usage in a multicast services control system (MSCS) for digital information transport according to claim 3, wherein the service provider designates a multicast group among the announced set of optimal multicast groups (D1, D2, D3), to joined receivers (STB1-STB5).

6. Method to optimize bandwidth usage in a multicast services control system (MSCS) for digital information transport according to claim 3, whereby the announcing is made in connection with the measuring.

7. Method to optimize bandwidth usage in a multicast services control system (MSCS) for digital information transport according to claim 2, wherein each receiver is preconfigured with the set of optimal multicast groups (D1, D2, D3).

8. Method to optimize bandwidth usage in a multicast services control system (MSCS) for digital information transport according to any of the previous claims, wherein the method for measuring bandwidth comprises the following further steps:
transmitting probe packets from the service provider along the paths in the joined multicast tree;
receiving the probe packets to the joined receivers (STB1-STB5);
estimating by each receiver, bandwidth on each path in the multicast tree.

9. Method to optimize bandwidth usage in a multicast services control system (MSCS) for digital information transport according to claim 8, wherein the measured bandwidth comprises available bandwidth or bottleneck link capacity.

10. Method to optimize bandwidth usage in a multicast services control system (MSCS) for digital information transport according to claim 8 wherein the algorithm used for measuring bandwidth is a bart method.

11. An apparatus suitable for optimizing bandwidth usage in a multicast services control system (MSCS) for digital information transport, which system comprises a service provider (Server) and service receivers (STB1-STB5) able to receive multicast streams from the service provider along multicast trees in an IP network (A/MNW), which apparatus comprises:
means for performing a multicast join by the service receivers to a multicast group associated with the service of interest provided by the service provider; characterized by
means for measuring bandwidth on paths in the joined multicast tree;
means for joining by each of the service receivers (STB1-STBS) an optimal multicast group (D1,D2,D3), which joining is based on the measurements;
means to base the joining on the measurements.

12. An apparatus suitable for optimizing bandwidth usage in a multicast services control system (MSCS) for digital information transport according to claim 11 comprising means to present a set of optimal multicast groups (D1, D2, D3) to the receivers.

13. An apparatus suitable for optimizing bandwidth usage in a multicast services control system (MSCS) for digital information transport according to claim 12, wherein the set of optimal multicast groups (D1, D2, D3) is announced from the service provider (Server).

14. An apparatus suitable for optimizing bandwidth usage in a multicast services control system (MSCS) for digital information transport according to claim 13, which apparatus further comprises:
means for sending measured bandwidth from the subscribing receivers (STB1-STBS) to the service provider (Server).

15. An apparatus suitable for optimizing bandwidth usage in a multicast services control system (MSCS) for digital information transport according to claim 13, which apparatus further comprises:
means in the service provider for designating a multicast group among the announced set of optimal multicast groups (D1, D2, D3), to joined receivers (STB1-STB5).

16. An apparatus suitable for optimizing bandwidth usage in a multicast services control system (MSCS) for digital information transport according to claim 13, which apparatus comprises means to make the announcing in connection with the measuring.

17. An apparatus suitable for optimizing bandwidth usage in a multicast services control system (MSCS) for digital information transport according to claim 12, which apparatus comprises means to pre-configure each receiver with the set of optimal multicast groups (D1, D2, D3).

18. An apparatus suitable for optimizing bandwidth usage in a multicast services control system (MSCS) for digital information transport according to claim 11, which apparatus comprises:
means for transmitting probe packets from the service provider along the paths in the joined multicast tree;
means for receiving the probe packets to the joined receivers (STB1-STB5);
means for estimating by each receiver, bandwidth on each path in the multicast tree.

19. A service receiving node suitable for optimizing bandwidth usage in a multicast services control system (MSCS) for digital information transport, which system comprises a service provider (Server) and service receivers (STB1-STB5) able to receive multicast streams from the service provider along multicast trees in an IP network (A/MNW), which node comprises:
means for performing a multicast join to a multicast group associated with the service of interest provided by the service provider; characterized by
means to receive measuring of bandwidth on paths in the joined multicast tree;
means for joining an optimal multicast group (D1,D2,D3), which joining is based on the measurements.

20. A service providing node suitable for optimizing bandwidth usage in a multicast services control system (MSCS) for digital information transport, which system comprises a service provider (Server) and service receivers (STB1-STB5) able to receive multicast streams from the service provider along multicast trees in an IP network (A/MNW), which apparatus comprises:
means for detecting a multicast join by the service receivers to a multicast group associated with the service of interest provided by the service provider; characterized by
means for initiating measuring of bandwidth on paths in the joined multicast tree.

21. A service providing node apparatus according to claim 20, which node further comprises:
means for announcing a set of bandwidths based on received measurements of bandwidth.

22. Article of manufacture comprising program code suitable for optimizing bandwidth usage in a multicast services control system (MSCS) for digital information transport, which system comprises a service provider (Server) and service receivers (STB1-STB5) able to receive multicast streams from the service provider along multicast trees in an IP network (A/MNW), which program code comprises:
computer readable program code for performing a multicast join by the service receivers to a multicast group associated with the service of interest provided by the service provider; which program code is characterized by:
computer readable program code for measuring bandwidth on paths in the joined multicast tree;
computer readable program code for joining by each of the service receivers (STB1-STB5) an optimal multicast group (D1,D2,D3), which joining is based on the measurements.
